(19) United States
(12) Patent Application Publication
(10) Pub. No.: US 2005/0189905 A1
(43) Pub. Date: Sep. 1, 2005

(54) Portable battery charging device

(76) Inventors: Hui-Hu Liang, Changhua Hsien (TW); Cheng-Tsai Tang, Hsi Chin City (TW)

Correspondence Address: TROXELL LAW OFFICE PLLC, SUITE 1404, 5205 LEESBURG PIKE, FALLS CHURCH, VA, 22041, US

(21) Appl. No.: 10/778,144

(22) Filed: Feb. 17, 2004

(51) Int. Cl. H02J 7/00

(52) U.S. Cl. 320/107

(57) ABSTRACT

A portable battery charging device in which the power plug base contains both a US specification plug and an EC specification plug, coupled by means of pivot posts and movably situated in the plug base. The two plugs can be individually or collectively rotated to lay flat or vertical. The conductive prongs and conductive pins extend through and protrude from the respective turn shafts as a first set of conductive tips and a second set of conductive tips. Two sets of conductive flexile elements are connected to a charging circuit board, the two sets of conductive flexile elements contacting the two sets of conductive tips. When the two sets of plugs are laid flat, the conductive tips are separated from the conductive flexile elements. Rotating either set to the vertical position causes the conductive tips of one set of lugs to be out of continuity with conductive flexile elements such that alternating current power from the other conductive prongs or pins is supplied to the charging circuit board.

### BACKGROUND OF THE INVENTION

1) Field of the Invention

The invention herein relates to battery chargers, specifically an improved portable battery charging device that utilizes two sets of different specification electric plugs that are movably coupled in a plug base and, furthermore, provides for insertion into differing specification US and EC mains power outlet sockets, while a charging circuit board controls indicator lights that flash in recurring sequences to effectively display battery charging status and thereby ensure that states of battery charging and saturation are accurately conveyed.

2) Description of the Prior Art

The U.S. Pat. No. 4,997,381 discloses a US specification and EC specification electric plug, the structure featuring a US specification plug (“second plug member”) and an EC specification plug (“first plug member”) that are rotatably mounted together and provides a US specification plug by a press switch (“push button”) that drives a slide block (“slider”) such that the slide block engaging the US specification plug is separated and an “L-shaped spring” situated in the “containing groove” of the side wall is released against the said US specification plug in the “rectangular shaped grooves” to provide the user with a US specification plug positioned at 90 degrees; utilizing the EC specification plug involves pulling it upward 90 degrees and is stacked on the said US specification plug to provide an EC specification plug for usage.

### SUMMARY OF THE INVENTION

I. Problems

1. When the said second plug member is impelled by the L-shaped spring, it only projects slightly from the rectangular shaped grooves such that the user must turn it to the 90-degree position, resulting in an additional operating procedure.

2. When the first plug member is utilized the pulling task requires that the second plug member be pulled up at the same time and if the two sets of the plugs are still inserted in a socket, hazardous electrical shock readily occurs.

3. The said device lacks indicator lights and the user cannot know the power status. Moreover, conventional battery charger circuits monitor whether voltage at the two ends of the said battery has reached a certain value, but after battery charging is completed, it is often the case that the battery is actually not fully charged, at which time the battery is found to be weak because of monitoring the state of saturation by voltage as opposed to monitoring by current.

II. Solution Approaches

1. The invention herein installs a torque spring on the turn shaft of the US specification plug and utilizes a laterally faceted push rod for retaining and release, enabling the US specification plug to be impelled out to a 90-degree state, eliminating user pulling and effectively simplifying operation.

2. The turn shafts of the US specification plug and the EC specification plug of the invention herein, have conductive tips that respectively protrude from the conductive prongs/pins, conductive flexile elements are connected to the charging circuit board and respectively straddled in position at two sets of plugs pulled to 90-degree positions to establish a state of continuity and, furthermore, can effectively provide for conductivity at each two sets of plugs positioned in the 90-degree state; a partition plate protrudes inward at the two sides of the EC specification plug that separates the conductive flexile elements from the conductive tips of the US specification plug, thereby providing for EC specification plug conductivity and US specification plug power termination, thereby safely achieving independent states of conductivity no matter which specification plug is utilized.

3. The said charging circuit power source input occurs through the conductive flexile elements connected to the power source and, thus, no matter what the situation of utilization, the power source is input via the conductive flexile elements and a programmable integrated circuit of the charging circuit controls a plurality of LEDs on the plug base to flash in a recurring sequence, while the said output charging current passes a resistor and a return circuit that biases voltage and establishes continuity at a transistor, controlling the operation of the programmable integrated circuit until the battery reaches a state of saturation, when current is reduced by the return circuit, switching out the transistor and controlling the LEDs flashing in a recurring sequence to cease operation, indicating that the battery charging status is completed; as such, the charging circuit of the invention herein monitors the charging current and ensures the accurate indication of the said battery charging.

### BRIEF DESCRIPTION OF THE DRAWINGS

FIG. 1 is an exploded drawing of the invention herein.

FIG. 2 is an isometric drawing of the invention herein, as viewed from the front.

FIG. 3 is an isometric drawing of the invention herein, as viewed from the back.

FIG. 4 is an isometric drawing of the invention herein that illustrates the use of the US specification plug.

FIG. 5 is an isometric drawing of the invention herein the illustrates the use of the EC specification plug.

FIG. 6 is a cross-sectional drawing of the invention herein.

FIG. 7 is an orthographic drawing of the invention herein, as viewed from the back.

FIG. 8 is a schematic diagram of the battery charging circuit of the invention herein.

### DETAILED DESCRIPTION OF THE INVENTION

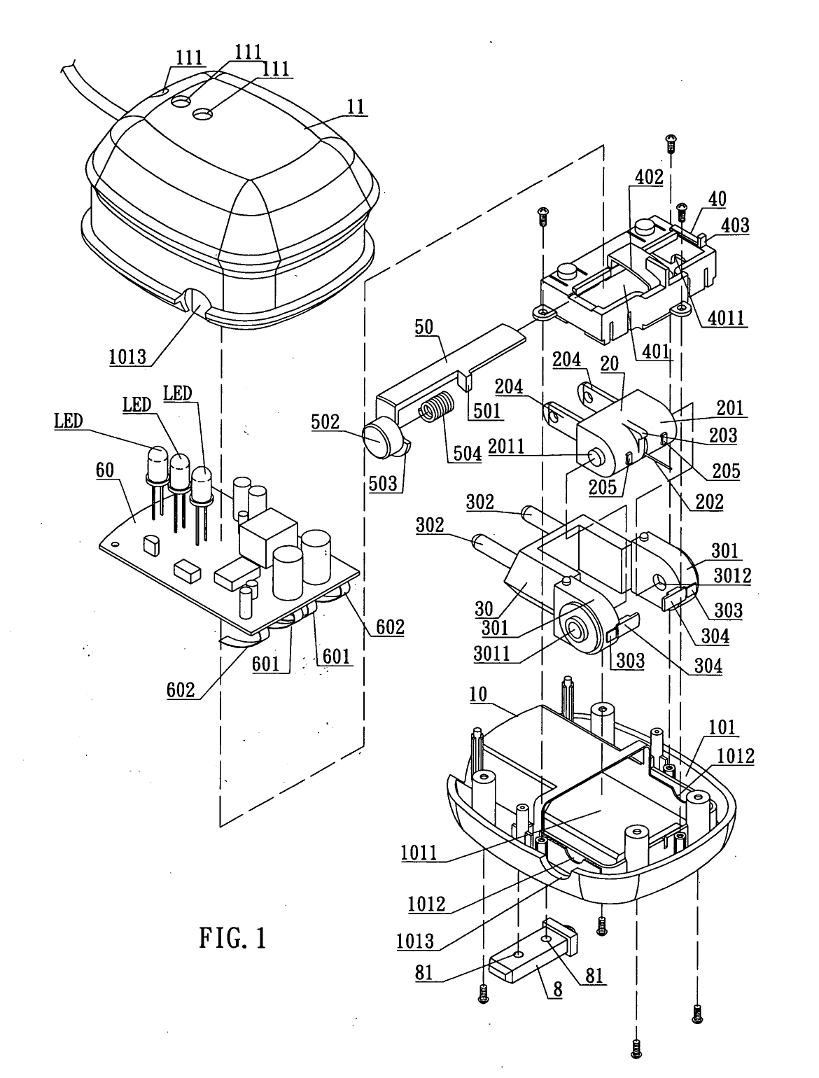

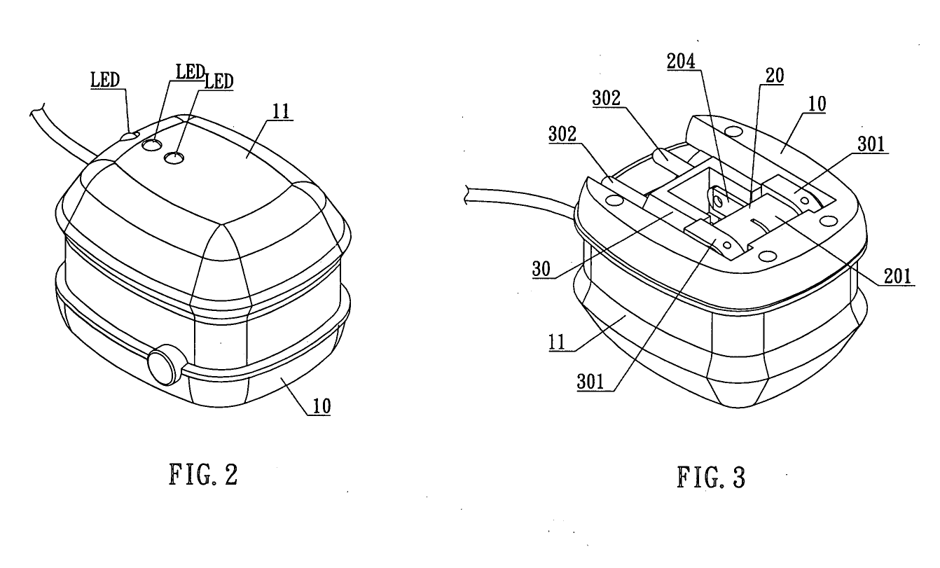

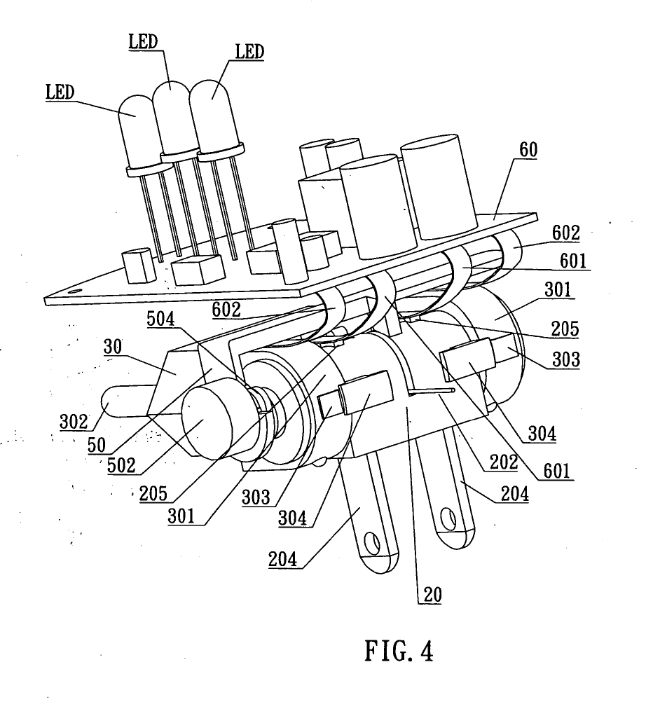

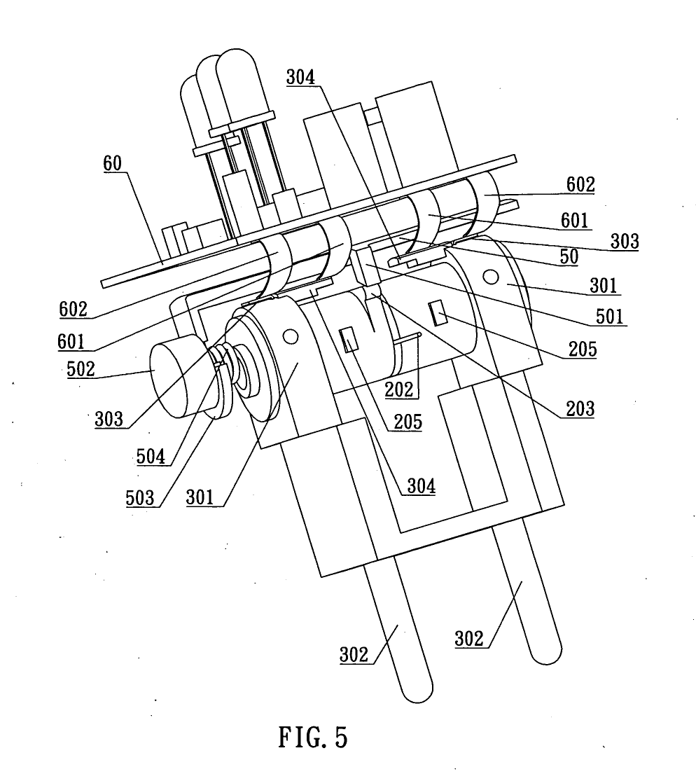

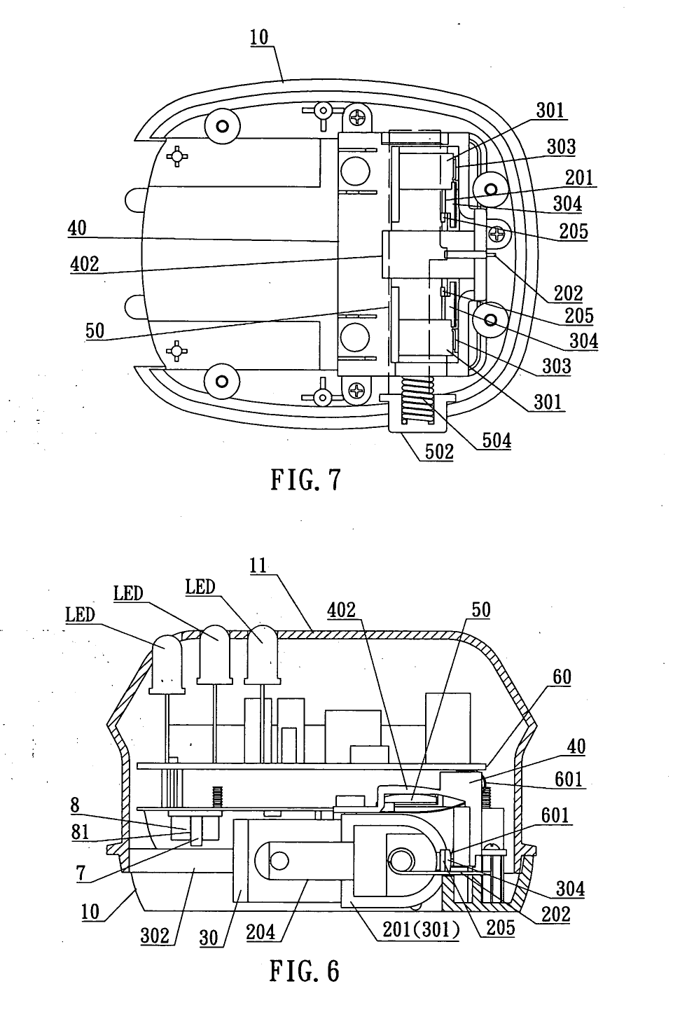

Referring to FIG. 1, FIG. 2, FIG. 3, FIG. 4, FIG. 5, FIG. 6, and FIG. 7, the invention herein consists of a plug base 10 having a compartment 101 with a portal 1011 fashioned in the compartment 101 and a semicircular notch 1012 formed on each of the two sides of the portal 1011 to provide placement space to seat a US specification plug 20 and an EC specification plug 30; the US specification plug 20 consists of a turn shaft 201 having a pivot post 2011 on each of its two sides and an internally embedded torque spring 202 and, furthermore, a lock tab 203 is suitably situated at the center of the turn shaft 201 and each of the conductive prongs 204 of the US specification plug 20 extends through it and protrude as a first set of conductive tips 205 from the turn shaft 201; the EC specification plug 30 consists of a turn shaft 301 having a main pivot post 3011 on each of its two outer sides, an axial hole 3012 in each inner side and, furthermore, the two conductive pins 302 of the EC specification plug 30 extend through it and protrude as a second set of conductive tips 303 from each of the two sides of the turn shaft 301 and, furthermore, an insulated partition plate 304 extends inward from the position of the said second set of conductive tips 303 on the turn shaft 301; when the US specification plug 20 pivot post 201 is inserted into the EC specification plug 30 axial hole 3012 and positioned therein, the US specification plug 20 is movably situated within the EC specification plug 30 such that the EC specification plug 30 and the US specification plug 20 are capable of swinging out together from the compartment 101 portal 1011, with the said the EC specification plug 30 main pivot post 3011 inserted into the semicircular notches 1012 at the two sides of the portal 1011, while the said torque spring 202 is against the lateral edge of the portal 1011 (as shown in FIG. 6 and FIG. 7); a retaining cap 40 having a reticulated opening 401 on-top, a semicircular notch 4011 is formed in the inner edge at each of the two sides of the reticulated opening 401 and, furthermore, a bridge 402 spans the said reticulated opening 401 and a positioning rod 403 is disposed at one side of the reticulated opening 401 to thereby cover the portal 1011 of the said compartment 101, enabling the said semicircular notches 1012 to keep the EC specification plug 30 main pivot post 3011 nested such that the EC specification plug 30 main pivot post 3011 is movably situated between the portal 1011 semicircular notches 1012 and the retaining cap 40 semicircular notches 4011; a lock plate 50 having a check block 501 disposed at a suitable position on its front edge as well as an actuator section 502 at the side edge and, furthermore, a check rim 503 along the periphery of the actuator section 502 that has a compressed spring 504 at its inner side, enabling the insertion of said lock plate 50 from the bridge 402, with the restraining capacity of the said positioning rod 403 and the loading action of the compressed spring 504 keeping the actuator section 502 check edge 503 against the inner edge of the through-hole 1013 formed by the assembled plug cover 11 and plug base 10, while the actuator section 502 projects from the said through-hole 1013 to provide for the inward pushing of the said actuator section 502, the compressed spring 504 automatically returning in a left and right shifting operation such that when the US specification plug 20 is lying flat, the said lock plate 50 check block 501 obstructs the US specification plug 20 lock tab 203 to prevent the decompression of the US specification plug 20 torque spring 202. Referring to FIG. 1, FIG. 4, and FIG. 5, a charging circuit board 60, the power source input ends of which are rotatively aligned into connection with the US specification plug 20 first set of conductive tips 205 and the EC specification plug 30 second set of conductive tips 303 via a first set of conductive flexile elements 601 and a second set of flexile elements 602 that are, furthermore, directly hooked into the reticulated opening 401 of the retaining cap 40; when the actuator section 502 is pushed inward, the lock plate 50 check block 501 separates from the US specification plug 20 lock tab 203, such that the US specification plug 20 is subjected to the decompression of the torque spring 202 and immediately postured in a perpendicular orientation (as shown in FIG. 5), while the first set of conductive tips 205 contact the first set of conductive flexile elements 601, thereby establishing continuity between the US specification plug 20 and the mains power socket to supply the electricity required by the charging circuit board 60; referring to FIG. 4, when the EC specification plug 30 is raised, the turn shaft 301 revolves until the second set of conductive tips 303 contacts the second set of conductive flexile elements 602, while the said EC specification plug 30 insulated partition plate 304 is inserted between the first set of conductive tips 205 and the first set of conductive flexile elements 601, terminating electricity to the US specification plug 20 such that when the EC specification plug 30 is utilized, the US specification plug 20 is in a zero-current state whether lying flat or vertically postured, and when the US specification plug 20 is utilized and the said EC specification plug 30 is lying flat, the latter is also in a zero-current state to effectively achieve safe electric power usage.

Referring to FIG. 3, FIG. 4, and FIG. 5, when closed, the said US specification plug 20 is pressed to the laid flat position, the said lock tab 203 slides past the lock plate 50 check block 501, enabling the said check block 501 to obstruct the lock tab 203 such that the US specification plug 20 is not subject to the decompression of the torque spring 202; additionally, the EC specification plug 30 can be directly pressed into the laid flat position to provide for utilization and storage convenience.

Referring to FIG. 1 and FIG. 6, to support EC specification three-hole safety sockets, insertion into a non-mains power connected third hole is required before the EC specification plug 30 conductive pins 302 can be inserted into the said socket, enabling the socket mains power connected holes to provide for the insertion of the plug conductive pins 302 (beyond the scope of the invention herein and not shown in the drawings); a locating post 7 is situated between the two conductive pins 302 when the EC specification plug 30 is lying flat in the compartment 101, an insulated insertion pin 8 having a locating hole 81 that is correspondingly positioned relative to the said locating post 7 provides for inserting the locating post 7 into the insulated insertion pin 8 locating hole 81 and accommodating the insulated insertion pin 8 on the said locating post 7; when utilized, the said insulated insertion pin 8 is removed from the locating post 7 and the insulated insertion pin 8 is directly inserted into the non-mains power connected hole of the socket, thereby providing for the insertion of the EC specification plug 30 into the mains power connected holes.

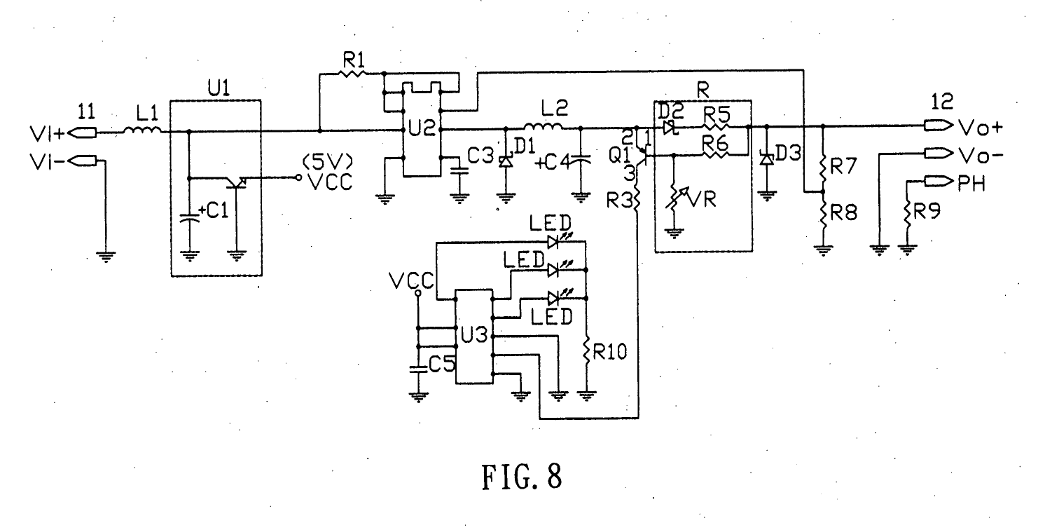

Referring to FIG. 1 and FIG. 8, the said power source is connected to the said charging circuit board 60 and, furthermore, a plurality of LEDs mounted on the said charging circuit board 60 project through the indicator holes 111 of the plug cover 11; the said plurality of LEDs are respectively connected to the output pins of a programmable integrated circuit (IC) U3 and the said input pins are connected to the output pin collector of a transistor Q1.

The said transistor Q1 base input pin is connected to a resistor and the return circuit R and then connected to the direct current output terminals 12 of a battery charger 1.

The said transistor Q1 emitter input pin is respectively connected to the output pin of a voltage regulator integrated circuit U2, a resistor, and the return circuit R.

The input pin of the said voltage regulator integrated circuit U2 is connected to the wave filter circuit U1 and then coupled to the power source input terminals 13.

As such, the said direct current proceeds through the wave filter circuit U1, a battery charging current is outputted from the voltage regulator integrated circuit U2 and a battery is charged from the direct current power source output terminals 13; the said battery charging current passes through the resistor and the return circuit R which biases the voltage and provides the continuity needed by the transistor Q1, enabling the transistor Q1 collector output signal to control the operation of the programmable integrated circuit U3, causing the plurality of LEDs to flash in a recurring sequence; when the battery reaches a fully saturated state, voltage is lowered via the resistor and return circuit R, switching the transistor Q1 out of circuit and thereby terminating the signal output from the transistor Q1, prompting the integrated circuit U3 circuit to maintain the illumination of a single LED among the plurality of LEDs, indicating that the battery charging operation is completed and, furthermore, the continuation of direct current state; as such, the charging current accomplishes both battery charging and monitoring to ensure accurate states of saturation and battery charging, but does not rely on voltage monitoring to charge the battery because voltage monitoring is incapable of reflecting the actual saturation and battery charging state.

The said programmable: integrated circuit U3 is capable of defining and controlling the flashing sequence of the plurality of LEDs to further enhance sensing performance.

1. An improved portable battery charging device consisting of a plug base, a US specification plug, an EC specification plug, and a charging circuit board 60, the features of which are:
A compartment is disposed in the bottom section of the said plug base with a portal fashioned in the said compartment and a semicircular notch formed on each of the two sides of the said portal to provide placement space to seat the said us specification plug and the said ec specification plug:
The said US specification plug consists of a turn shaft having a pivot post on each of its two sides and a torque spring embedded inside and, furthermore, a lock tab is suitably situated at the center of the said turn shaft and each of the conductive prongs of the said US specification plug extends through it and protrude as a first set of conductive tips from the said turn shaft.
The EC specification plug consists of a turn shaft having a main pivot post on each of its two outer sides, an axial hole in each inner side and, furthermore, the two conductive pins of the said EC specification plug extend through it and protrude as a second set of conductive tips from each of the two sides of the said turn shaft and, furthermore, an insulated partition plate extends inward from the position of the said second set of conductive tips on the said turn shaft.
A retaining cap having a reticulated opening on top, a semicircular notch is formed in the inner edge at each of the two sides of the said reticulated opening and, furthermore, a bridge spans the said reticulated opening and a positioning rod is disposed at one side of the said reticulated opening to thereby cover the said portal of the said compartment, enabling the said semicircular notches to keep the said EC specification plug main pivot post nested such that the said EC specification plug main pivot post is movably situated between the said portal semicircular notches and the said retaining cap semicircular notches.
A lock plate having a check block disposed at a suitable position on its front edge as well as an actuator section at the side edge and, furthermore, a check rim along the periphery of the said actuator section that has a compressed spring at its inner side, enabling the insertion of said lock plate from the said bridge, with the restraining capacity of the said positioning rod and the loading action of the said compressed spring keeping the said actuator section check edge against the inner edge of a through-hole formed by the assembled plug cover and said plug base, while the said actuator section projects from the said through-hole to provide for the inward pushing of the said actuator section, the said compressed spring automatically returning in a left and right shifting operation.
The charging circuit board has power source input ends that are rotatively aligned into connection with the said US specification plug first set of conductive tips and the said EC specification plug second set of conductive tips via a first set of conductive flexile elements and a second set of conductive flexile elements that are, furthermore, directly hooked into the said reticulated opening of the said retaining cap.
As such, when the said US specification plug pivot post is inserted into the said EC specification plug axial hole and positioned therein, the said US specification plug is movably situated within the said EC specification plug such that the said EC specification plug and the said US specification plug are capable of swinging out together from the said compartment portal, with the said the EC specification plug main pivot post inserted into the said semicircular notches at the two sides of the said portal, while the said torque spring is against the lateral edge of the said portal, such that when the said US specification plug is lying flat, the said lock plate check block obstructs the said US specification plug lock tab to prevent the decompression of the said US specification plug torque spring; when the said actuator section is pushed inward the said lock plate check block separates from the said US specification plug lock tab, such that the said US specification plug is subjected to the decompression of the said torque spring and immediately postured in a perpendicular orientation, while the said first set of conductive tips contact the said first set of conductive flexile elements, thereby establishing continuity between the said US specification plug and mains socket to supply the electric power required by the said charging circuit board; when the said EC specification plug is raised, the said turn shaft revolves until the said second set of conductive tips contacts the said second set of flexile elements, while the said EC specification plug insulated partition plate is inserted between the said first set of conductive tips and the said first set of conductive flexile elements, terminating electricity to the said US specification plug such that when the said EC specification plug is utilized, the said US specification plug is in a zero-current state whether lying flat or vertically postured, and when the said US specification plug is utilized and the said EC specification plug is lying flat, the latter is also in a zero-current state to effectively achieve safe electric power usage; when closed, the said US specification plug is pressed to the laid flat position, the said lock tab slides past the said lock plate check block, enabling the said check block to obstruct the said lock tab such that the said US specification plug is not subject to the decompression of the said torque spring; additionally, the said EC specification plug can be directly pressed into the laid flat position to provide for utilization and storage convenience.

2. As mentioned in claim 1 of the improved portable battery charging device of the invention herein, the said charging circuit board outputs a battery charging current through a wave filter circuit and a voltage regulator integrated circuit, the features of which are:
A plurality of LEDs project through the said plug cover that are connected to the output pins of a programmable integrated circuit which defines a range of different recurring flashing sequences.
A transistor, the collector output pin of which is connected to the input pin of the said programmable integrated circuit, its base connected to a resistor and a return circuit and the emitter connected to the input pins of a voltage regulator integrated circuit, a resistor, and a return circuit.
As such, the said resistor and the said return circuit biases the voltage and enables continuity with the said transistor to provide for various recurring sequences of flashing by the said plurality of LEDs as defined by the said programmable integrated circuit and when the battery reaches a fully saturated state voltage is lowered via the said resistor and the said return circuit, reducing voltage at the said transistor and thereby terminating the signal output such that only a single LED remains illuminated as defined to serve as a power source indication, thereby achieving current monitoring to ensure accurate states of battery charging and saturation.

3. As mentioned in claim 1 of the improved portable battery charging device of the invention herein, the present invention supports insertion into the non-mains power connected hole of EC specification safety sockets, the features of which are:
A locating post is situated between the said two conductive pins when the said EC specification plug is lying flat.
An insulated insertion pin having a locating hole that is correspondingly positioned relative to the said locating post.
As such, this provides for inserting the said locating post into the said insulated insertion pin locating hole and accommodating the said insulated insertion pin on the said locating post, thereby providing for the insertion of the said EC specification plug into the mains power connected holes.
